(19) United States
(12) Patent Application Publication
(10) Pub. No.: US 2022/0214742 A1
(43) Pub. Date: Jul. 7, 2022

(54) USER-SPECIFIC INTERACTIVE OBJECT SYSTEMS AND METHODS

(71) Applicant: Universal City Studios LLC, Universal City, CA (US)

(72) Inventors: Wei C. Yeh, Orlando, FL (US); Rachel E. Rodgers, Orlando, FL (US)

(21) Appl. No.: 17/563,564

(22) Filed: Dec. 28, 2021

Related U.S. Application Data
(60) Provisional application No. 63/172,447, filed on Apr. 8, 2021.
(60) Provisional application No. 63/133,625, filed on Jan. 4, 2021.

(51) Int. Cl. G06F 3/01; G06K 19/07; A63F 9/24; A63J 5/04; A63H 33/26; H02S 10/40

(52) U.S. Cl. CPC G06F 3/011; G06F 3/016; G06K 19/0723; A63F 9/24; A63J 5/04; A63J 2005/003; H02S 10/40; A63F 2009/2442; A63F 2009/2451; A63F 2009/247; A63F 2009/2479; A63H 33/26

(57) ABSTRACT

A system that includes an interactive object comprising a special effects system, a controller that controls operation of the special effects system, and environmental sensors configured to generate sensor data. The system includes a central controller that operates to receive user profiles and receive sensor data from the environmental sensors of an interactive environment. The central controller is then able to identify a user based on the collected sensor data, wherein the identified user is associated with the interactive object. The central controller is then able to characterize a movement of the interactive object based on the sensor data and communicate instructions to the controller of the interactive object to activate a special effect of the special effect system, wherein the instructions are based on the user profile, the user profile being associated with the identified user, and the characterized movement or action of the interactive object.

### CROSS-REFERENCE TO RELATED APPLICATIONS

This application claims priority to U.S. Provisional Application Ser. No. 63/133,625, entitled “USER-SPECIFIC INTERACTIVE OBJECT SYSTEMS AND METHODS,” and filed on Jan. 4, 2021, and to U.S. Provisional Application Ser. No. 63/172,447, entitled “USER-SPECIFIC INTERACTIVE OBJECT SYSTEMS AND METHODS,” and filed on Apr. 8, 2021, both of which are hereby incorporated by reference in their entireties for all purposes.

### BACKGROUND

The present disclosure relates generally to the objects for use in interactive environments, such as a game environment or an amusement park. More specifically, embodiments of the present disclosure relate to an addressable interactive object that facilitates interactive effects, such as one or more special effects.

This section is intended to introduce the reader to various aspects of art that may be related to various aspects of the present disclosure. This discussion is believed to be helpful in providing the reader with background information to facilitate a better understanding of the various aspects of the present disclosure. Accordingly, it should be noted that these statements are to be read in this light and not as admissions of prior art.

In recent years, it has become more common to create interactive environments that include props, scenery, audiovisual and other media elements, and special effects that improve a guest's experience and that support a particular narrative of the environment. In certain interactive environments, it is enjoyable for the guests to have their own objects, e.g., props or toys that interact with the environment in various ways. In one example, a guest may wish to interact with the interactive environment using a handheld device to generate a particular effect that simulates effects from a movie or game. Often, such interactive environments are crowded, and traditional techniques for wireless communication may be challenging when multiple guests all carry their own handheld objects.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below

In accordance with an embodiment, an interactive object comprising a special effects system disposed in or on the housing, a controller disposed in or on the housing that controls the operation of the special effects system, and a plurality of environmental sensors configured to generate sensor data. The embodiment also includes a central controller that operates to receive a plurality of user profiles from a plurality of users and receive sensor data from the plurality of environmental sensors of an interactive environment. The central controller identifies a user of the plurality of the users based on the sensor data, wherein the identified user is associated with the interactive object. The central controller then characterizes a movement or action of the interactive object based on the environmental sensor data and communicates instructions to the controller of the interactive object to activate a special effect of the special effect system, wherein the instructions are based on the user profile of the plurality of user profiles, the user profile being associated with the identified user, and the characterized movement or action of the interactive object.

In accordance with another embodiment, a method comprising receiving sensor data from a plurality of sensors in an interactive environment; identifying a plurality of interactive objects and a plurality of users in the interactive environment based on the sensor data; associating an identified interactive object with an identified user; tracking the movement of the identified interactive object using the sensor data; and communicating instructions to the identified interactive object to activate an on-board special effect based on the tracked movement and a user profile of the identified user.

In accordance with another embodiment, an interactive object comprising a housing and a detectable marker disposed on or in the housing that operates to reflect a first portion of electromagnetic radiation from an environment. Communication circuitry on or in the housing to the housing that operates to receive a second portion of the electromagnetic radiation from the environment, transmit interactive object identification information of the interactive object responsive to receiving the second portion of electromagnetic radiation, and receive special effect instructions. A controller on or in the housing that receives the special effect instructions and generates a special effect command. The interactive object also comprises a special effects system that receives the special effect command and activates a special effect based on the special effect command.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of an embodiment of an interactive object system, in accordance with present techniques;

FIG. 2 is a schematic illustration of features of an embodiment of the interactive object system, in accordance with present techniques;

FIG. 3 is a flow diagram of the interactive object system, in accordance with present techniques;

FIG. 4 is a schematic illustration of the communication system of the interactive object system, in accordance with present techniques;

FIG. 5 is a flow diagram of a method of assigning a user profile, in accordance with present techniques; and

FIG. 6 is a flow diagram of a method for detecting an interactive object and facilitating effect emission of the interactive object, in accordance with present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. One or more specific embodiments of the present embodiments described herein will be described below. In an effort to provide a concise description of these embodiments, all features of an actual implementation may not be described in the specification. It should be noted that in the development of any such actual implementation, as in any engineering or design project, numerous implementation-specific decisions must be made to achieve the developers' specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

Users in an interactive environment or participating in an immersive experience may enjoy carrying a handheld object or wearing a costume element that aligns with a theme, such as a sword, stuffed animal, hat, wand, jewelry, or other prop. In one example, interactions are mediated by external objects that recognize the object (e.g., via object recognition or wireless communication) and activate external actions based on the recognition. Such an arrangement permits the objects to be implemented as relatively inexpensive objects, with the more complex and costly elements of the interactions being off-board or external to the passive device. While feedback systems can be situated as components of the environment, the ability to generate feedback in or on a hand held or worn device can facilitate a deeper level of immersion into the environment.

In addition, individually addressing one user and/or one interactive object within a crowded environment with many users and many interactive objects is challenging. Crowds, objects, or scenery may inhibit line of sight for particular types of sensors (e.g., cameras, optical beam sensors). Further, some sensors may have diminished feedback during inclement weather or limited light situations. These environmental factors can impair the ability of an interactive system to identify a specific user and to direct interactive effects to a specific interactive object associated with the specific user. In addition, users, and their interactive objects, tend to move within an interactive environment. Precisely locating a user and object within a crowded environment is also challenging. While facial recognition technologies may permit identification of a single user, facial recognition is computationally intensive and slow. Further, users in interactive environments may be wearing hats, masks, sunglasses, or other prop items that render recognition even more difficult.

The disclosed interactive object techniques permit user and/or interactive object identification and targeting to mediate elements of an interactive environment. In embodiments of the disclosure, the system locates a particular user within a crowd and activates or directs special effects to an interactive object carried or worn by the user without necessarily activating other interactive objects in the area. In contrast to communication mediated by mobile devices or other portable electronics, the disclosed techniques operate to identify relatively simple interactive objects that do not necessarily include any communication packages. Accordingly, the identification is based on environmental data that is collected within an interactive environment and that is used to identify and locate both user and interactive object. Further, the disclosed techniques account for situations in which a particular user is using an interactive object that is not pre-registered to the system or otherwise linked to the particular user. In one example, users may switch or share interactive objects within a family group. While wireless communication of object identification information to the system permits identification of the interactive object itself, identification information alone would not recognize a situation in which the user carrying the object changes throughout the day. The present techniques permit dynamic updating and addressing of interactive objects in a manner that is specific to the identity of the particular user interacting with the object at a particular time.

The interactive object system collects data from multiple sensing modalities, which may be pooled and/or arbitrated, to permit the user to be identified with greater accuracy while utilizing minimal or reduced processing power. The data can include radio frequency data, optical sensing methods, 3D time of flight systems, and other sensing systems. This facilitates identification of a specific user in a crowd, and leads to personalizing the effect to the user in a manner that may be linked to the identity of the interactive object carried by the user. This positive user identification also facilitates the linking of an interactive object to a specific user, which further personalizes the user experience in a crowded environment.

Such interactive objects may be, in an embodiment, a prop or toy used within an interactive environment to permit greater variability in special effect control by using individualized user interactives. The user interactive enables a user profile to be associated with the interactive. This profile is used to select special effects that are based upon the user profile. Further, it should be appreciated that, while embodiments of the disclosure are discussed in the context of a toy, prop, or handheld object, such as a sword, wand, token, book, ball, or figurine, it should be understood that the disclosed embodiments may be used with other types of objects. Such objects may include wearable objects, such as clothing, jewelry, bracelets, headgear, medallions, or glasses.

In addition, the object may be a prop or scenery item within an interactive environment. The interactive environment may be part of an immersive area, such as an amusement park, an entertainment complex, a retail establishment, etc. The disclosed systems and methods may include at least one interactive environment of a themed area having a common theme and may additionally include different interactive environments within the single themed area. Further, the disclosed systems and methods may include additional or other interactive environments having different themes but that are contained within an immersive area, such as a theme park or entertainment venue. The interactive environment may be a live show, wherein the user in the audience may be able to participate using their object. When referring to an interactive environment, the interactive environment may include a certain area within which a user can interact with interactive elements within the area. Further, an interactive environment may also include different locations that are geographically separated from one another or that are dispersed throughout an amusement park. The interactive environment may also be in a remote location separate from an immersive area. For example, the user may be able to establish an interactive environment at their home or any other location via a user electronic device that may be configured to interact with the object.

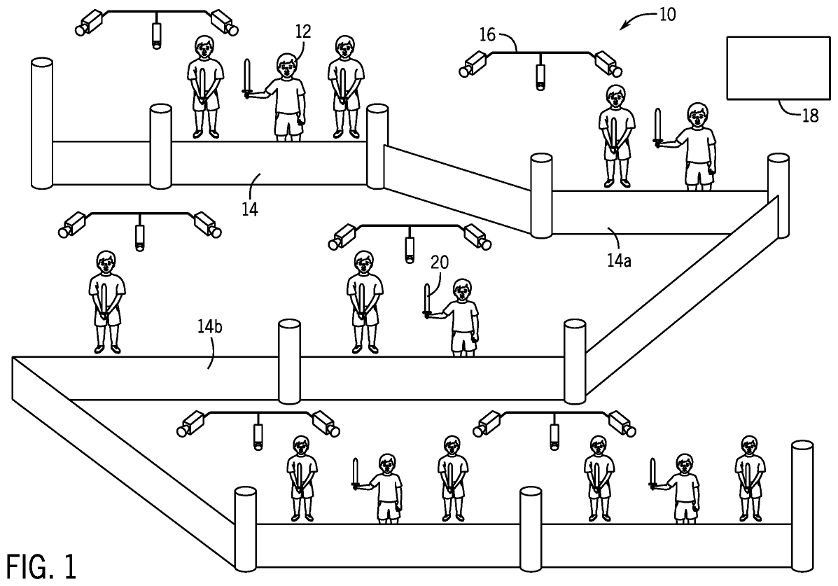

Certain aspects of the present disclosure may be better understood with reference to FIG. 1, which generally illustrates the manner in which an interactive object control system 10 may be integrated within an interactive environment in accordance with present embodiments. As illustrated, a plurality of users 12 (e.g., guests) move about one or more interactive environments 14, e.g., that may be within an amusement park or entertainment venue. The users 12 may have a handheld or wearable interactive object 20 that moves with the user 12 throughout the interactive environment 14. The user's interactive object 20 facilitates output of user-specific special effects based on the user interactions 12 via the interactive object 20 within the interactive environment 14. The effects may provide feedback to the user 12 that an interaction is occurring or has successfully occurred.

The interactive object control system 10 includes a plurality of environmental sensors 16 dispersed throughout the interactive environment 14 and, in certain embodiments, between the various areas of an interactive environment 14 or in different interactive environments. The environmental sensors 16 generate sensor data. The sensor data may be user data, such as data from images or camera feeds of one or more users in the interactive environment 14. Additionally or alternatively, the sensor data may be interactive object data, such as data indicative of a location or motion of the interactive object 20 in the interactive environment 14. In one embodiment, the acquired sensor data may be used to track the user's location within and between different interactive environments 14. The environmental sensors 16 send the sensor data to a central controller 18, and the data can be processed to identify the user 12 during the user's interactions within the interactive environment 14. The environmental sensors 16 may also track user movement throughout the interactive environment 14. In an embodiment, the user data of all the users 12 in the interactive environment can be pooled and/or arbitrated to identify one or more users 12 within the interactive environment 14. Further, the sensor data may be used to identify one or more interactive objects 20 within the interactive environment 14. Still further, the interactive object control system 10 may target user-specific special effects to a particular interactive object 20 and/or a particular location in the interactive environment 14 based on the acquired data. Thus, in an embodiment, the user 12 may experience the interactive object 20 as having the appearance of a passive or low technology device. However, the user's own actions using the interactive object 20 may trigger an on-board special effect on the interactive object 20 and/or a location-specific special effect in the interactive environment 14. These effects can be selected by the central controller 18 based on user actions, user profile information, or historical or other data associated with the user 12 and/or the interactive object 20. Thus, the effects that are experienced by the user 12, and that may also be visible to other nearby users 12, are variable or unpredictable within the interactive environments 14 leading to increased enjoyment.

In one example, the interactive object control system 10 is capable of tracking real-time user location. For example the user 12 may leave one interactive environment 14a and enter a second interactive environment 14b. The user's location is tracked via the environmental sensors 16, so that the user's location can be transmitted to the central controller 18, and user linkage to the interactive object 20 can occur more efficiently throughout the plurality of interactive environments 14.

In an embodiment, the user's interactive object 20, upon entering the interactive environment 14, is triggered to transmit interactive object identification data to the environmental sensors 16 that then transmit the interactive object identification data to the central controller 18. The central controller 18 receives the object identification data and utilizes the data to link the specific interactive object 20 to a specific user 12 of the plurality of users in the interactive environment 14. In one embodiment, the user identification occurs based on received sensor data. The sensor data is assessed to identify one or more users 12 in an area of an interactive environment. Characteristics of the users extracted from the sensor data (e.g., extracted facial features, skeletal features, gait, limb characteristics or movement, matching to previously-identified clothing items, or detectable biometric characteristics) are then used to identify individual users 12 from a set of identified users 12 known to be generally within the area. The users 12 generally within the interactive environment 14 may form a subset of a total set of all users within an attraction or a theme park based on the collected sensor data, and user identification may be expedited by dynamic updating of the relevant subset as a likely candidate pool.

The identified user 12 is then linked to the interactive object 20 by the central controller 18 so that a user profile can be updated based on the user interactions via the linked interactive object within the interactive environment 14. Further, specific effects or actions can be targeted to the identified user 12 and/or linked interactive object 20.

In an embodiment, the user 12 can perform a specific motion or gesture with the interactive object 20, which is tracked via environmental sensors 16 and communicated to the central controller 18. The central controller 18 then processes the motion data, in some instances in combination with the user profile data or object profile data, to generate a special effect communication, e.g., special effect instruction, that is personalized based on one or more of the motion data, user profile data, and object profile data. The interactive object 20 then receives this communication and activates a personalized special effect based on the specific user 12, the specific object 20, and/or the tracked motion. The user 12 is then able to perceive distinct special effects (e.g., visual, auditory, haptic) throughout the interactive environment 14, including in some instances on or through the object 20. The user's profile, and in some instances the object's profile, stored in the central controller 18, is updated to store user's interaction data within the interactive environment 14.

The special effect instructions may be personalized according to the user profile associated with the user's interactive object 20. The user profile may comprise user skill level (e.g. length of time of use with interactive object, accuracy of gestures with interactive object over time) and user identity (e.g. pre-selected theme or other user preferences). For example, the special effect command corresponding to a user's gesture with the interactive object 20 may be personalized to the user 12 according to the user profile by varying audio, haptic, or visual aspects of the special effect command sent to the user's interactive object 20. For example, characteristics such as intensity (e.g., light intensity, audio intensity, haptic effect intensity) of the special effect can be adjusted in a rules-based manner. The central controller 18 may identify the user 12 and receive the user profile comprising user skill level and user identity. The central controller 18 can set special effect commands based on the user skill level and user identity. In one example, the special effect command causes activation of a light on the interactive object 20 having a specific color and/or intensity corresponding to the user skill level and user identity in combination with the sensor data associated with gesture performance data received by the central controller 18. The user 12 may possess an intermediate skill level and the central controller may determine, based on the sensor data, that the gesture was performed accurately. This information will be utilized by the central controller 18 to generate or adjust a specific special effect based on skill level and correct performance of the gesture. For example completing a figure eight gesture in combination with an intermediate skill level may be determined by the central controller 18 to correspond to a special effect command associated with illuminating the user's interactive object 20 green. Real-time special effect adjustment may occur over the course of the special effect (e.g., with changes in color intensity corresponding to higher or lower quality changes in the user actions). Another user who possesses a beginner skill level but performed the same figure eight gesture may cause the central controller 18 to generate a special effect command associated with an audio clapping or a sparking effect.

If an individual not associated with the interactive object 20 attempts to perform a gesture or use the interactive object 20, the central controller may detect that the individual is not linked to the interactive object 20 and/or that the individual is linked to a different interactive object 20. The central controller 18 may generate an effect to convey to the individual that they are the incorrect user of the interactive object 20. For example, the central controller 18 may send an audio special effect command to the interactive object 20 to output an audio error message. This will indicate to the individual that they are the incorrect user of the interactive object 20. In an embodiment, it is envisioned that every good faith interaction with the interactive object 20, regardless of the user identity or the skill level, can generate some sort of perceivable feedback at the interactive object 20.

In another embodiment, the user 12 may enter the interactive environment 14, and a special effect command may be transmitted before any motion is made via the interactive object 20 based on the user profile data or object profile data. For example, when the user 12 enters the interactive environment 14, the user's interactive object 20 is triggered to transmit object identification data into the area. The interactive object data is then transmitted to the central controller 18. The user 12 may have a specified characteristic within their user profile that triggers a special effect based on the specific characteristic. For example, the user could choose a specific identification color for their profile, and the central controller 18 could communicate this specific color output to the interactive object 20, and enable the interactive object 20 to emit light from a specific color LED housed within the interactive object 20 corresponding to the user profile characteristic.

In an embodiment, the central controller 18 may send a general special effect command to all user interactive objects 20 currently in a bounded area or within a specific interactive environment 14. The central controller 18 may send a general special effect command to illuminate every interactive object 20 in the bounded area or within a specific interactive environment 14 a specific color. The bounded area may be a specified distance or radius of the interactive environment 14, so that the interactive objects 20 in the bounded area receive the same special effect command.

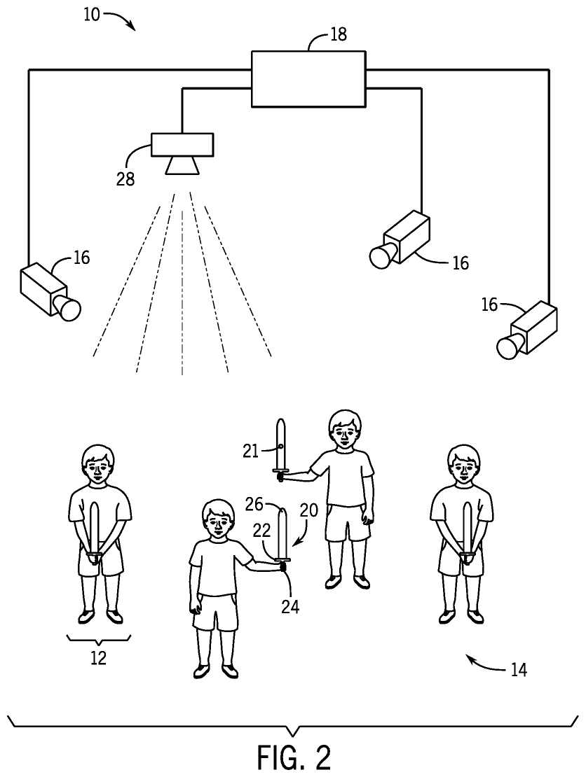

FIG. 2 illustrates a schematic diagram of interactions of the interactive object control system 10. In one embodiment, the interactive object control system 10 receives or detects interactive object information (e.g., unique device identification number or code) from one or more interactive objects 20 in an area of an interactive environment 14 which includes an area in range of emitters 28 and sensors 16 of the interactive object control system 10. In one embodiment, the information is based on a detectable marker 21 (e.g., a barcode, a quick response code, a patterned retroreflective marker, a glyph) on a housing 22 of the interactive object 20 and is detected by the interactive object control system 10 such that the interactive objects 20 provide the information passively. The interactive objects 20 may include a mix of passive and active elements that may permit different modes of communication and activation depending on the environment.

As illustrated, the users 12 interact with the interactive object control system 10 that may include one or more emitters 28 (which may be all or a part of an emission subsystem having one or more emission devices and associated control circuitry) that emits one or more wavelengths of electromagnetic radiation (e.g., light such as infrared, ultraviolet, visible, or radio waves and so forth). The interactive object control system 10 may also include one or more environmental sensors 16 (which may be all or a part of a detection subsystem having one or more sensors, cameras, or the like, and associated control circuitry) that detects one or more of signals transmitted from the interactive object 20, a detectable marker 21 on the interactive object 20, and the users 12 in the interactive environment 14 as described above in FIG. 1. To control operations of the emitter 28 and the environmental sensors 16 (emission subsystem and sensor subsystem) and perform various signal processing routines resulting from the emission, and detection process, the interactive object control system 10 also includes the central controller 18 communicatively coupled to the emitters 28 and the environmental sensors 16. As illustrated, the interactive object control system 10 may include the interactive object 20 (illustrated as a handheld object) that includes a housing 22 having an exterior surface 24 that, in an embodiment, includes a grip sensor, and the interior of the housing which includes communication circuitry 26. The housing 22 may also include a detectable marker 21.

As discussed the communication circuitry 26 may actively communicate a device identification of the interactive object 20 to the environmental sensors 16 in the interactive environment 14. The communication circuitry 26 may include a radio-frequency identification (RFID) tag. The communication circuitry 26 can communicate device identification of the interactive object to the environmental sensors 16 (implemented as receivers) of the interactive environment 14, which in turn pass the information to the central controller 18 of the interactive object control system 10. The communication circuitry 26 enables wireless communication of device identification information between the hardware of the interactive object 20 and the hardware of the interactive object control system 10 so that interactive object information that relates to one or both of a user profile or an object profile can be dynamically updated and used to generate personalized commands sent to the interactive object 20 and/or the interactive environment 14 from the central controller 18

In an embodiment, the emitter 28 is external to (e.g., spaced apart from) the interactive object 20. The emitter 28 operates to emit electromagnetic radiation, which is represented by an expanding electromagnetic radiation beam for illustrative purposes, to selectively illuminate, bathe, or flood the interactive environment 14 in the electromagnetic radiation. The electromagnetic radiation beam, in certain embodiments, may be representative of multiple light beams (beams of electromagnetic radiation) being emitted from different sources of the emitter or emitters 28 (all part of an emission subsystem that includes one or more emitters 28). For example, the source may be a visible light source, an infrared light source, etc., to emit the desired wavelength of electromagnetic radiation. Further, the emitter 28 may include one or more sources of different types, such as light emitting diodes, laser diodes, or other sources. The electromagnetic radiation beam is intended to generally represent any form of electromagnetic radiation that may be used in accordance with present embodiments, such as forms of light (e.g., infrared, visible, UV) and/or other bands of the electromagnetic spectrum (e.g., radio waves and so forth). However, it is also presently recognized that, in certain embodiments, it may be desirable to use certain bands of the electromagnetic spectrum depending on various factors. For example, in one embodiment, it may be desirable to use forms of electromagnetic radiation that are not visible to the human eye or within an audible range of human hearing, so that the electromagnetic radiation used does not distract guests from their experience. Further, it is also presently recognized that certain forms of electromagnetic radiation, such as certain wavelengths of light (e.g., infrared) may be more desirable than others, depending on the particular setting (e.g., whether the setting is “dark,” or whether people are expected to cross the path of the beam). The detectable marker 21 may be a retroreflector, e.g., operating to reflect light in a particular range (800-1100 nm range in an embodiment) that reflects the emitted light from the emitter 28. The reflected light is detected at one or more environmental sensors 16 to generate sensor data indicative of a presence or motion of the interactive object 20.

The interactive environment 14 may correspond to all or a part of an amusement park attraction area or interactive environment, including a stage show, a ride vehicle loading area, a waiting area outside of an entrance to a ride or show, interactive features dispersed within an amusement park, and so forth. The interactive environment 14 may also be movable or transitory, such as incorporated within a parade or a street performance. The interactive environment 14 may be interacted with by user 12 individually, such as part of a game, scavenger hunt, or nonlinear narrative experience. In an embodiment, the emitter 28 is fixed in position within the environment while the interactive object 20 moves within the area of an interactive environment 14 and receive the electromagnetic radiation signal. Accordingly, the interactive object 20 may be detected (e.g., located within the interactive environment 14), tracked via the environmental sensors 16 in the area, and communicated with to activate one or more on board special effects of the interactive object 20 via emitted and detected electromagnetic radiation of the interactive object control system 10.

As generally disclosed herein, the detection of the interactive object 20 is controlled by the central controller 18, which drives the emitter 28. The activation may be indiscriminate, such that the emitter 28 continuously emits electromagnetic radiation of the appropriate wavelength or frequency that corresponds to the communication circuitry 26 and the device information that is communicated, and any interactive object positioned within the interactive environment 14 and oriented towards the emitter 28 is activated to emit a signal of device identification to the environmental sensors 16, dispersed throughout the interactive environment 14. The sensors may include radio frequency sensors, optical sensors, 3D time of flight sensors, facial recognition sensors and other sensing systems to aid in the user 12 and the interactive object 20 identification. In an embodiment, as disclosed in more detail herein, the activation may be selective, such that the central controller 18 operates to locate and process the transmitted object identification data via the communication circuitry 26 of the interactive object 20 and, upon locating and detecting, drive the emitter 28 to direct a signal given by the central controller 18 to the interactive object 20 such that the activation of the special effect of the interactive object 20 may be turned on or off depending on a desired narrative or user actions.

For example, the user 12 may enter the interactive environment 14 with their respective interactive object 20. The interactive object may wirelessly transmit interactive object information or may interact with (reflect) emitted light in the interactive environment 14 to provide interactive object data to the environmental sensors 16 in the interactive environment 14. The environmental sensors 16 may also obtain interactive object data from a detectable marker 21 on the interactive object 20. The object identification data is then transmitted to the central controller 18 for processing. The environmental sensors 16 (e.g., facial recognition sensors, 3D time of flight sensors, optical sensors) may also detect user-related information, such as image information. The central controller 18 may identify users 12 via the sensor data to narrow down the user pool in the interactive environment 14 such that object identification data can be linked to the specific user 12 more efficiently.

The user 12 may then perform a motion or gesture with their interactive object 20. The motion data of the interactive object 20 is collected by the environmental sensors 16 in the interactive environment 14 and transmitted to the central controller 18. The central controller 18 then utilizes the user data in combination with the motion data to send a personalized effect response to the communication circuitry 26 of the interactive object 20 that has been previously linked to the user 12 by the central controller 18. If the user 12 has previously visited the interactive environment 14, the personalized effect response can be differentiated by the central controller 18 to be different than previous effect commands sent to the user's interactive object 20 in the interactive environment 14. The specific gesture or motion performed with the interactive object 20 can also cause effect differentiation. The specific motions performed with the interactive object 20 by the user 12 can trigger motion specific effects. In one embodiment, the motion data may be compared to a stored set of motions and assessed for accuracy based on preset quality metrics. The effect based on accuracy and/or performed motion can be designated to correspond to a certain color emission of light from the interactive object 20, or other effect emitted from the special effects system of the interactive object 20.

The central controller 18, based on the user's interactions with their interactive object 20 in the interactive environment 14, may trigger special effects that vary throughout the course of the effect. In one example, a power boosting device is controlled to increase the luminance of the special effect output via the interactive object 20. The signal boosting may be implemented by controllable radio frequency energy emitters, or through additional infrared emitting power sources in an optical power harvesting example. The radio frequency emitters may direct and/or focus the radio frequency energy transmission beam from a radio frequency emitter to a particular interactive object 20 based on the interactive object's 20 detected location. The direction and focus of the beam to the location of the interactive object 20 facilitates an increase in the interactive object's 20 available power and allow for the device to output a special effect using the extra available power with a higher intensity and/or luminance relative to other interactive objects 20 in close proximity. In this manner, a single interactive object 20 in a group can be singled out to, for example, form a high intensity beam of light. The radio frequency energy transmission may include Ultra high frequency (UHF) energy transmissions to power the interactive object's 20 special effects. The change in luminance may be dynamic and tied to user actions with the interactive object 20, so that when the user is improving, getting closer to a goal (e.g., getting “warmer” to finding an object), or performing a movement pattern with a higher quality metric, the luminance increases, and when the user is doing relatively less well (e.g., getting “cooler”), performing a less accurate (lower quality metric) motion pattern, the luminance decreases. These user actions are tracked in real-time by the environmental sensors 16 so that the system 10 can provide feedback via the output on the interactive object 20 in substantially real-time. Accordingly, a nature of the special effect may be based on a quality metric being above or below a threshold. The quality metric may be based on accuracy of motion patterns of the interactive object 20, distance of the interactive object 20 from a goal (within a certain distance being above a quality threshold), or interaction of the interactive object 20 within the interactive environment 14. In another embodiment, the intensity of the luminance could vary depending on the phase of the activation. Or, discrete color illuminations could be tied to particular interactives, the completion of a specific gesture using the interactive object 20, or a series of gestures. In another embodiment, the special effect variance discussed above, and the use of illumination and color discussed in connection with various embodiments herein, may be expressed by other sensory effects including haptic, such as a vibration of the interactive object 20, or sound, such as a tone emitted by the interactive object 20.

In another example, the power boosting effect may be implemented by utilizing an external device, e.g., a mobile device, associated with the user 12. The interactive object 20 may include a Near-Field Communication (NFC) coil located in the interior of the interactive object 20. The NFC coil may facilitate charging and/or power boosting for the interactive object 20 by gaining charge via transmission of energy from an external device associated with the user (e.g. mobile phone, NFC charger, which may be implemented as a toy or wearable device). The external device may include a holster and/or holder for the interactive object 20 so that the interactive object 20 may be continuously charged as the user 12 moves about the interactive environments 14. The interactive object 20 may also include a rechargeable energy source (e.g. battery, super capacitor) that may buffer and store energy from the radio frequency emitter, the user's mobile device, an accessory of the interactive object, or any combination thereof. The rechargeable energy source may be used to accomplish a power boosting effect at any point in time and to ensure that the interactive object 20 has stored energy for effect output regardless of location of the interactive object 20. In another embodiment, the NFC coil may enable pairing of the interactive object 20 to the user's mobile device to allow for interactivity between the user's mobile device and the user's interactive object 20. For example, the mobile phone may pair with the user's interactive object 20 and allow transmission of interactive object performance data to the mobile device. The interactive object 20 performance data may be processed via an application of the mobile device and displayed to the user 12 so that the user can view their performance statistics in real time.

In another embodiment, the interactive objects 20 may be recharged throughout the day if on display and/or not in use by the user 12. The interactive object 20 may be recharged by utilizing the optical power harvesting method described above. The interactive object 20 storage area may include a radio frequency emitter that may continuously emit energy towards the interactive object storage area to recharge the interactive objects 20 when not in use, so that they are fully charged when the user 20 obtains the interactive object 20. The interactive objects 20 in the storage area may also be charged via a near field device that may be incorporated into a shelving unit or other storage space. This near field charging method may serve as a 1:1 top off (e.g. charging) method. The optical power harvesting method may be used in combination with other charging methods for the interactive object 20, such as mid-range to long-range charging methods via charging over Ultra high frequency (UHF) radio frequencies and charging using near-field communication (NFC) methods (e.g., NFC coil located within the interactive object 20, near field device). It should be understood that any of the above charging methods may be implemented individually or in combination throughout user 12 interactions to power or charge the interactive object 20. Further, the discussed power harvesting techniques may be used to directly power on-board special effects of the interactive object 20 and/or may be used to charge a battery or power storage of the interactive object 20 that is in turn used to power the special effects.

The central controller 18 may detect and store historical data associated with past interactions between the user's interactive object 20 and other interactive objects. For example, the user's interactive object 20 may have interacted with an opponent's interactive object 20 during a battle scenario. The central controller 18 may update the user's profile to include historical information pertaining to the user's 12 interaction with the opponent's interactive object 20 during the battle scenario. The central controller 18 may then detect at a later time that the user's interactive object 20 is attempting to battle with the same opponent's interactive object 20. The central controller 18 may then receive the historical data comprising the past battle scenario data and differentiate special effect commands sent to the user's interactive object 20 to activate new special effects based upon previous battle interactions.

In another example, the user may enter the interactive environment 14, and an initial effect command may be sent to the interactive object 20 based off the interactive object identification via wireless transmission from the on board communication circuitry 26 of the interactive object 20 to the central controller 18, and user identification via environmental sensors 16. This initial identification may enable the central controller 18 to send an initial command based off object identification 20 and the user 12 identification. For example, the interactive object 20 could receive an initial command to project a certain color light from an LED housed within the special effects system of the interactive object 20. This projection of LED light color could be based on user's preference or user's level of experience with the corresponding interactive object 20. The user could then perform a motion or gesture with the interactive object 20. The environmental sensors 16 disposed throughout the environment collect the motion data of the interactive object, and the motion data is then transmitted to the central controller 18. The central controller 18 based on the motion data can then send another special effect command to the interactive object 20. The communication circuitry receives the command sent from the central controller 18, and outputs a different color LED based on the motion or gesture performed. This enables the user to observe a constant output of effects from the interactive object 20 during the user's entire experience in the interactive environment 14.

For example, the interactive object 20 may be sent commands to perform discrete illumination sequences throughout the user's experience in a specific interactive environment 14. For instance, the interactive object 20 may illuminate a certain color LED based on initial identification and linkage to user profile by the central controller 18. The user 12 may then perform a gesture or series of gestures and based on the accuracy of these gestures the interactive object 20 may be sent commands to illuminate a certain color LED, or one or more LED's of different colors in a specified sequence or in conjunction depending on the accuracy of the performed gesture. For example, the accurate performance of a gesture determined via the central controller 18 triggers the central controller 18 to send a second command to the interactive object 20 to illuminate an alternate color LED from the initial identification or a sequence of alternate colors of LEDs, which may be based on whether the gesture was performed accurately. The illumination of one or more specific color LEDs may correspond to a themed aspect of the interactive experience. The color may correspond to a group or house affiliation stored in the user profile that corresponds to a pre-selected color option, to connect the user 12 to their user profile throughout the user experience.

In another embodiment a mobile device of the user 12 may be used to identify the interactive object 20 and link the user 12 to the interactive object 20. The interactive object 20 may have high level symbolic representations (e.g. runes and/or a sequence of runes) etched on the exterior of the interactive object 20. The runes may also be any other symbol or etching system used to represent a unique pattern on the exterior casing of the interactive object 20. The order of the runes may correspond to a unique identifier for the interactive object 20. For example, rune A and rune B may appear in order AB on a first interactive object and order BA on a second interactive object. The runes may be order specific so that order AB corresponds to a different unique identifier than order BA. This order specific identification of the runes enables a greater number of unique identifiers to be available while using a smaller number of runes.

To link the user 12 to the interactive object 20, the user 12 may utilize their mobile device to scan or take a picture of the interactive object 20 utilizing the camera of the mobile device. The user 12 may also download an application on their mobile device that is able detect the runes from the picture obtained via the camera of the mobile device. The application may have access to a database that contains all the unique identifiers for each rune combination. The mobile device may obtain the user 12 information via the application and link the user's interactive object 20 via the unique identifier obtained from the runes with the user information. The mobile device may be configured via the application to transmit the user information and associated interactive object information to the central controller 18. The central controller may utilize the user 12 and interactive object information to transmit special effect commands based on the user 12 being associated with the interactive object 20 via the mobile device. This method can be implemented in combination with the environmental sensor 16 method of identifying users 12 and linking each user 12 to their respective interactive object 20. The identification of interactive object 20 via the user mobile device can aid in identification in a crowded environment in combination with the environmental sensors 16, or to aid in addition to the environmental sensors 16 for user identification.

The special effects of the interactive object 20 can be varied or selected based on user action. In another embodiment, the special effect command may be determined based on a gesture of the interactive object 20, a verbal command by the user 12 of the interactive object 20, the user profile comprising a level of the user 12, or any combination thereof. Certain gesture and verbal action combinations may be associated with higher intensity or rarer generated special effects relative to a gesture or verbal command alone. For example, the user 12 may perform a first gesture with the interactive object 20 without the user 12 reciting a verbal command. The central controller 18 may receive sensor data related to the gesture performed with the interactive object 20 and link the interactive object 20 to the user 12 and the user profile corresponding to the user 12. The central controller 18 may then transmit a special effect command to the interactive object 20 based on the gesture performed by the user with the interactive object 20 and the user profile. The user 14 may alternatively perform the first gesture in combination with a verbal command. The central controller 18 may be sent sensor data comprising data related to the gesture performed and the verbal command. The central controller 18 may generate a special effect command based on the gesture and the verbal command different than the command for the gesture-only case. This enables special effect command generation to be differentiated based on multiple combinations of the gesture and verbal commands. The special effect may also be differentiated depending on the skill level of the user associated with the user profile as discussed previously. The user 14 may then be able to receive more personalized feedback and attempt more combinations of gestures and verbal commands.

Further the special effect command may specify the intensity level of illumination to be emitted from the interactive object 20. The intensity level of the illumination may be tied to a performance of a motion or gesture, an experience level of the user 12, or the user's previous experiences in the interactive environment 14, or any combination thereof. The color of the illumination may also be specified via the special effect command, and may be associated with a particular interactive object 20, or be dependent upon the correct completion of a specific gesture or series of gestures with the interactive object 20. For example, a user may initially enter an area of an interactive environment 14 of the plurality of interactive environments 14. The users interactive object 20 via wireless transmission sends object identification information to the central controller 18. The central controller 18 may then link the interactive object information to a respective user 12 in the interactive environment 14. The central controller may then send an initial special effect command specifying a specific intensity level and color of illumination based off of interactive object information. The user 12 may then complete a series of gestures with their interactive object 20. The environmental sensors 16 transmit the motion data of the interactive object 20 to the central controller 18 which accesses the data for accuracy and sends a special effect command specifying a color and/or intensity level for the illumination effect that may be different from the initial command, based off accuracy of gestures performed with the interactive object 20. For example, the interactive object 20 may illuminate a green color LED at a high intensity for the correct performance of a gesture, and for the incorrect performance of a gesture illuminate a red color LED at a low intensity. The interval of the illumination may also be specified via the special effect command received by the interactive object 20, and may specify a longer interval (time period of illumination) of illumination or a different intensity level based on the performed action or object identification information.

In another embodiment, the environmental sensors 16 may be unable to identify a user to link to a specific interactive object of the plurality of interactive objects 20. The central controller 18 utilizes the interactive object data received, and recognizes that no best match of the interactive object 20 to the user 12 can be conducted. In this embodiment, the central controller sends a default effect command retrieved from a plurality of default effects stored in the central controller 18 to the interactive object 20 that was not matched. This enables the user 12 of the unmatched interactive object 20, to observe a special effect.

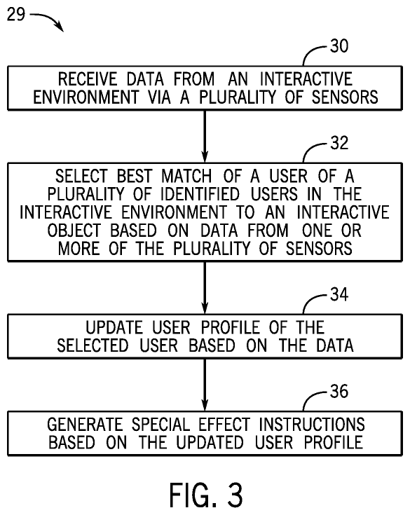

FIG. 3 illustrates a process flow diagram for a method 29 that permits association of the user 12 to their respective interactive object 20 in the interactive environment 14 and enables updating the respective user's profile based on the user's interaction 12 within the interactive environment 14. For example, the method 29 may efficiently select a user 12 of a pool of pre-identified users 12 without conducting de novo user recognition using more computationally intensive techniques.

In the embodiment, a plurality of the users 12 move about freely in the area of an interactive environment of a plurality of interactive environments 14. As users 12 move about the interactive environment 14 the interactive object control system 10 acquires user data and interactive object data collected via the environmental sensors 16 dispersed throughout the interactive environment 14. The data is received by the interactive object control system 10, such as at the central controller 18 of the interactive object control system 10 (block 30).

In one example, the system 10 receives unique identification information from a tag on the interactive object 20 or any interactive objects in range of the environmental sensors 16 of the interactive environment 14. The system 10 also receives location information associated with the interactive objects 20. The location information may be based on radio frequency triangulation from the tag, such that the interactive object 20 is linked/identified to particular identification information based on an estimation of location via the sensor signals of multiple sensors 16. Thus, the system 10 can identify a particular interactive object 20 via wireless communication and link the interactive object 20 to a unique identification number. In another example, the location information is additionally or alternatively determined via sensing of detectable markers on the interactive object 20. The detectable markers are located in space or tracked via the environmental sensors 16. The location information of a sensed detectable marker can be associated with a particular identification tag by determining if an identified interactive object 20 is co-located with a sensed detectable marker or may be based on an estimated closest distance/likely match between a detected retroreflective marker and a triangulated RFID signal origin location associated with (e.g., that transmitted) the identification information of a particular tag. Further, in certain embodiments, the detectable marker may also encode identification information and/or the interactive object 20 may include a light emitter that emits the identification information and that is tracked in space to provide location/motion information.

User identification may also contribute to interactive object identification. Certain interactive objects 20 may be calibrated to or linked to a particular user profile. Thus, the user associated with the user profile is a most-likely candidate to be holding the interactive object 20. Identification of the user within the area of an interactive environment (e.g., via camera data of the sensors 16) can be used to identify the associated interactive object 20. Further, assessment may be based on historical data. Interactive objects 20 may be assumed to be linked to the most-recent user from an adjacent the interactive environment 14 until new data is received.

The system 10 analyzes the plurality of user and interactive object identification data to select a best match of a user of the respective users 12 present in the interactive environment 14 to a respective interactive objects 20 in the interactive environment 14 (block 32). The matching may be rules-based as provided herein. In an embodiment, the system matches or associates an interactive object 20 to a single user 12 of the plurality of users 12 for each interaction. For example, the interactive environment 14 may include multiple users 12, some of whom do not carry interactive objects 20. Thus, the rules may permit some users 12 to be unassociated with any interactive object 20. However, each interactive object 20 may be required to be associated with at least one user 12. The rules-based matching may use proximity as a factor in matching, with detected interactive objects 20 being likely to be associated with a closest user 12. However, an elongated interactive object 20 held at arms-length may be potentially closer to a head/face of a different user 12. Accordingly, additional factors such as identification of the object 12 as being hand-held, where appropriate, or being worn in an appropriate manner, may also be considered. As disclosed herein, the acquired data from the environmental sensors 16 may include camera data that is processed and provided to the analysis to assess these factors.

Further, the rules may identify a set of potential users within a larger area, such as a theme park, as candidates for user identification. In one embodiment, high quality image recognition and user profile linking to the user image and/or other user characteristics (gait, clothing, appearance based-metrics, biometrics) is performed using more computationally intensive sensors and processing at a designated area, such as a main entrance of a theme park. Of the set of potential users, only a subset will be within a particular the interactive environment 14 or an attraction. Thus, rather than performing de novo recognition analysis, the interactive object control system 10 may identify best matches within the set and using less computationally intensive user recognition analyses to permit more efficient operation of the interactive object control system 10.

The data collected by the environmental sensors 16 is processed to narrow down the prospective user pool of the interactive environment 14. The system can utilize the user pool to more efficiently match users 12 to their respective interactive objects 20. The ability to narrow down the possible user pool for a specific interactive environment 14 facilitates identification of users 12 within the crowded interactive environment 14. Through utilization of multiple forms of sensing to identify both users and interactive objects, users 12 can be matched to their respective interactive objects more efficiently. Further, the interactive object control system 10 may be able to identify cases in which the interactive object 20 is shared between different users. When a first user interacts with the interactive environment 14 using the interactive object 20, the interactive object control system 10 may generate different special effect instructions (e.g., on-board special effects activated on the interactive object 20 and/or of the interactive environment 14) relative to those generated for a second user 12 using the same interactive object 20. Thus, the interactive object 20 is perceived to respond differently to different users 12.

The user profile associated with the selected best match user 12 and the identified interactive object 20 is then updated by the system to include the association. The user profile is also updated to include user location information corresponding to the specific interactive environment 14 and interactive object data relating to the interactive object 20 interactions within the interactive environment 14 (block 34). The interactive object 20 is sent personalized special effect commands based on the user's previous experiences in the interactive environments 14 (block 36). This enables the corresponding user profile to be updated when the user 12 enters a new interactive environment 14, such that the special effect command sent to the user's interactive object 20 can be differentiated or varied at repeat visits based on the user profile containing previous user information relating to location of the user 12 and experience of the user 12 and the user's interactive object 20 in previous interactive environments 14 visited.

It should be understood that the method 29 may be implemented to build a system-generated user profile that may be coordinated with a user-generated user profile stored on the interactive object control system 10 or that, for users who do not register a profile, may be used independently. The user profile information provided by the user may include user age, preferences, attraction visit history, park visit history, family group information, payment information, etc. The interactive object control system 10, as provided herein, may also add interactive object data to the user profile. This may be added in a manner that is invisible to the user, but that is accessed by the interactive object control system 10 to guide interactive experiences within interactive environments 14.

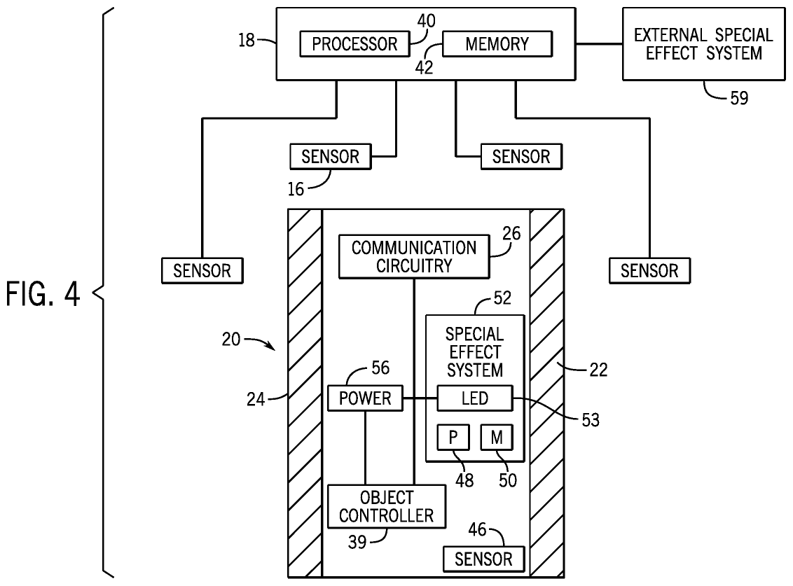

FIG. 4 is a schematic diagram of the interactive object control system 10 demonstrating the communication between the interactive object 20 and various components of the interactive object control system 10 external to the interactive object 20. Additionally or alternatively, the disclosed detection or locating of the interactive object 20 as provided herein may involve environmental sensors 16 (e.g., proximity sensors, optical sensors, image sensors) of the system that provide location or movement data of the interactive object 20.

In operation, the environmental sensors 16 sense the interactive object 20 and/or the user 12 through image recognition (e.g., interactive object recognition, facial recognition), detection of a retroflective marker on the interactive object 20, 3D time of flight systems, radio frequency sensing, and optical sensing in addition to other sensing methods that detect that the user 12 and/or the user's interactive object 20 is present in the interactive environment 14. The interactive object 20 can also include communication circuitry 26 that may include a radio-frequency identification tag (RFID) that can be activated through transmission of electromagnetic radiation to output object identification data to the environmental sensors 16 in the interactive environment 14. This data can then be utilized by the processor 40 disposed in the central controller 18 to link the interactive object 20 to a specific user 12 in the interactive environment 14. The linkage of the user 12 to the user's interactive object 20 enables a personalized special effect signal to be sent to the communication circuitry 26 of the interactive object 20, and enables the user profile to be updated based on the user's interactions 12 within the interactive environment 14 via the central controller 18. This special effect signal sent by the central controller 18 is then processed by an object controller 39 housed in the interactive object 20, and activates the special effect system 52 that is powered either passively, e.g., via power harvesting (optical power harvesting) or actively by a power source, to emit a special effect that is personalized to the user's profile. Further, the interactive object 20 may include an active or passive RFID tag that communicates device identification information. In an embodiment, the RFID tag may be a controllable backscatter RFID tag.

In the depicted embodiment, the communication circuitry transmits interactive object device information to the central controller 18. In an embodiment, one or more sensors 46 of the interactive object 20 detect electromagnetic radiation that is projected into the interactive environment 14. The communication circuitry 26 either emits a wireless signal with interactive object device data via radio frequency identifier (RFID) tag or infrared light signal. The environmental sensor 16 receives the interactive object device data and transmits this data to the central controller 18. The interactive object data is utilized by the processor 40 in combination with the user identification data from the environmental sensors 16 and/or memory 42. A personalized special effect signal, based on the device and/or user identification, is then transmitted back to communication circuitry 26. The communication circuitry 26 passes the command to the object controller 39 of the interactive object 20. The object controller 39 is able to send the command to the special effects system 52 of the interactive object 20. A processor 48 and memory 50 enable special effect instructions to be stored and enable special effect activation and control corresponding to the command sent.

In the depicted embodiment, the environmental sensors 16 detect the user's presence in the interactive environment 14 and collect user data in addition to tracking of the interactive object 20 based on a performed gesture. The environmental sensors 16 may include camera facial recognition sensors, 3D time of flight sensors, optical sensors, and radio frequency sensors. These environmental sensors 16 are dispersed throughout the interactive environment 14 so that the users 12 can be tracked and located efficiently, and a personalized effect command can be sent to the communication circuitry 26 of the user's associated interactive object 20. The environmental sensors 16 can be used to identify the user 12 so that the user information and device information provided by the central controller 18 enables a dynamic user profile to be created and updated as the user 12 moves about the plurality of interactive environments 14. The identification of the user 12 corresponding to the interactive object 20 may be accomplished using grip recognition and/or vision recognition via facial recognition cameras dispersed throughout the interactive environments 14.

The memory 42 of the central controller 18 may store user profiles of the plurality of users 12 who have previously been matched to the plurality of interactive objects 20 within the interactive environment. The user profiles can then be updated as user experiences with the user's interactive object 20 take place throughout the plurality of interactive environments 14. The central controller 18 is able to update user profile based on user's experiences with their interactive object 20 within the area of an interactive environment of the plurality of interactive environments 14. This enables special effects to be differentiated based on user profile throughout interactive environments 14, and within multiple visits to the same interactive environment 14. The user profile can also include information that is associated with the user, which may comprise user specific characteristics that are predetermined before first use of object and after first use of object. These characteristics can enable further differentiation of special effect commands based on the specific user 12. For example, if a user requested a specific affiliation to a group or selected a specific category from a preset selection of categories, the user profile can be updated to display this information. The central controller 18 may then send a special effect signal based in part on the user profile. This may comprise the output of a specific color LED, a sound effect, a haptic effect, a visual projection, or any combination thereof.

In some embodiments, the central controller 18 may be able to link only a threshold or preset number of the users 12 to the interactive object 20. The number of the users 12 that can be linked to the interactive object 20 may be limited to a specific threshold to maintain device security of the interactive objects 20. For example, if a specific interactive object 20 has been linked to two users, the central controller 18 may recognize that the threshold number of users for the specific interactive object 20 is two and may not identify a third user that is trying to utilize the interactive object 20. The central controller 18 may send a signal (e.g. effect) to the third user's interactive object 20 to communicate to the third user that the interactive object 20 is not able to be linked to the third user and the third user may need to obtain another interactive object 20. This may be accomplished through a visual effect command that directs the interactive object 20 to illuminate a specific color, a special effect command that directs the interactive object 20 to output a sound effect that communicates the interactive object 20 is not able to be linked, or any other effect method.

In one example, a particular detected motion pattern of the interactive object 20 (based on interactive object data from the environmental sensors 16) may be assessed by the central controller 18. Certain types of motion patterns may be associated with activating a red light on the interactive object 20 while other types of motion patterns may be associated with activating a blue light. Based on the detected pattern, the instructions for activation of the light color are transmitted to the interactive object 20. The special effect instructions may include instructions to set an intensity, hue, or interval pattern of light activation. One or more of these may be varied based on characteristics of the sensed motion pattern and/or user profile characteristics. In an embodiment, the activation of the on-board special effect provides feedback to the user that a successful interactive experience has occurred, and lack of the special effect or a muted special effect (dim light activation) is indicative that the interaction should be improved or altered.

The central controller 18 that drives the emitter 28 and that receives and processes data from the environmental sensors 16 may include the one or more processors 40 and the memory 42. The processors 40, 48 and the memory 42, 50 may generally referred to herein as “processing circuitry.” By way of specific but non-limiting example, the one or more processors 40, 48 may include one or more application specific integrated circuits (ASICs), one or more field programmable gate arrays (FPGAs), one or more general purpose processors, or any combination thereof. Additionally, the one or more memory 42, 50 may include volatile memory, such as random access memory (RAM), and/or non-volatile memory, such as read-only memory (ROM), optical drives, hard disc drives, or solid-state drives. In some embodiments, the central controller 18 may form at least a portion of a control system configured to coordinate operations of various amusement park features, such as an amusement park attraction and control system. It should be understood that the subsystems of the interactive object control system 10 may also include similar features. In one example, the special effect system 52 may include processing capability via the processor 48 and the memory 50. Further, the object controller 39, when present, may also include integral processing and memory components.

The central controller 18 may be part of a distributed decentralized network of one or more central controllers 18. The decentralized network of the one or more central controllers 18 may communicate with a park central controller and park central server. The decentralized network of the one or more central controllers 18 facilitates reduction in processing time and processing power required for the one or more central controllers 18 dispersed throughout the one or more interactive environments 14. The decentralized network of the one or more central controllers 18 may be configured to obtain user profiles by requesting the profile from a profile feed stored in the park central server. The user profile feed may comprise user accomplishments associated with the interactive object, user experience level, past user locations, and other user information. The one or more central controllers 18 may act as edge controllers that subscribe to a profile feed comprising a plurality of user profiles stored in a park central server and cache the feed to receive one or more user profiles contained in the feed.

In some embodiments, the interactive environment 14 may include one or more central controllers 18. The one or more central controllers 18 within the interactive environment 14 may communicate with each other through the use of a wireless mesh network (WMN) or other wireless and/or wired communication methods. The special effect commands may be generated by the central controller 18, a distributed node of the central controller 18, or by a dedicated local controller associated with the interactive environment 18 and communicated to the interactive object 20.

In another embodiment the sensor 46 of the interactive object 20 may include an array of individual pressure or grip sensors that provide pressure information to the object controller 39. The array may be a capacitive or force sensitive resistor array of at least 16 or at least 256 individual sensors. The object controller 39, under passive power, can use the signals from the array to calibrate based on sensor data indicative of a characteristic grip biometric for a particular user. The calibration process may activate a feedback via the special effect system 52 (e.g., activation of one or more light sources 53 in a pattern associated with matching the interactive object to a particular user, activating a speaker, or another special effect). The calibration process may be limited to one user or a threshold number of users, so that only a preset number of users may be linked to the interactive object 20 to maintain device security of the interactive object 20.

The interactive object 20 may include a power source 56, which may be a battery or a power-harvester, such as a radio frequency based power-harvesting antenna or an optical harvester. The power source 58, such as the harvested power, is used to power one or more functions of the interactive object 20, such as the special effect system 52. For example, the power source 58 may power multiple light emitting diodes with red, green, blue and white (RGBW) emitters.

As discussed herein, the interactive object 20 may provide object identification information via optical emissions that are detected by the environmental sensor 16. The light source 53 of the special effect system 52 may be used to transmit the optical information, or another light source may be used. Identification may be achieved through the use of radio frequency, infrared, and/or a RGBW-based, visible light method of identity transmission. In the case of an infrared or visible method of identity transmission, the illuminated output of the light source 53 can be modulated to encode an identity signal while being indiscernible to the eye. When using RGBW light emitter as a method of output and identification, a second emitter in the infrared range can be utilized to transmit supplemental identifier information. Interactive object identification via a first technique (receiving an RFID signal) may be combined with interactive object sensing or tracking via a second technique (e.g., detecting a retroreflective marker). The identification information may be linked to the tracking information as provided herein (e.g., proximity assessment, matching to a common user).

In another embodiment, the central controller 18 may send a special effect command to an external prop or display that includes an external special effect system 59 in addition to sending a special effect command to the interactive object 20. For example, the user 12 could make a gesture or motion with their interactive object 20. The environmental sensors 16 collect motion data, and transmit the motion data to the central controller 18. The central controller 18 utilizes user profile data and motion data to send a personalized special effect command to the interactive object 20. In addition to the special effect command sent to the interactive object 20 the central controller 18 may send an additional special effect command to an external prop or display in the area of an interactive environment. The special effect command sent to the external prop or display can comprise a visual effect, sound effect, or another type of effect command.

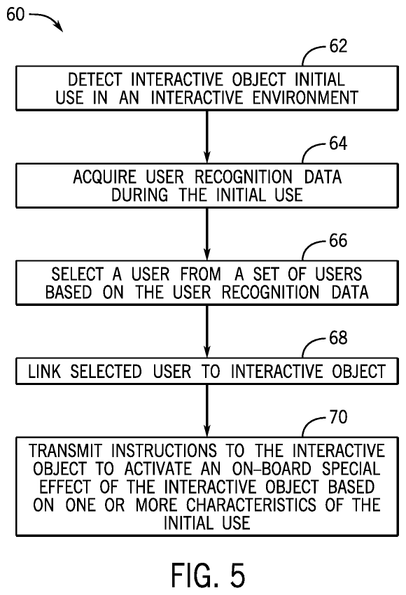

FIG. 5 illustrates a process flow diagram of a method 60 for associating a respective user 12 with their interactive object 20. The method includes a process of detecting a first or initial use of an interactive object 20 (block 62) and acquiring user recognition data during the first use (block 64). This identification of the user is facilitated by acquired data gathered from multiple environmental sensors 16 including facial recognition sensors, 3D time of flight systems, and other modes of user recognition. The sensor data collected from the environmental sensors 16 is pooled together so that the possibility of users present in the interactive environment 14 can be determined, and user possibilities are narrowed down. Thus, a single user 12 is selected from a set of users 12 based on the user recognition data. The data pooled from the multiple environmental sensors 16 reduces processing power needed for identification of users in an area of an interactive environment, and expedites user identification and increases accuracy of user identification. If user cannot be identified via a method of facial recognition, another sensing method is able to identify the user thus increasing accuracy of user identification. In the event that a user cannot be identified by the available methods, a default user profile may be associated with the identified interactive object and used until a user identification is made. The location of the possible users 12 to the user interactive object 20 can then be narrowed down to a smaller pool of users (block 66) until a single user 12 is selected. The selected user is linked to the interactive object 20. A first use special effect command is transmitted to the interactive object 20 to activate an on-board special effect that may be specific to characteristics of the initial use (block 68).

In one embodiment, the central controller 18 detects that no profile has been created for the user 12 and the user's interactive object 20, thus triggering the creation of a new profile to store the user information. A user profile is assigned to the user 12 based on identification of the user 12 via environmental sensors 16 and detection of the user's interactive object 20. The profile is stored in the central controller 18, so that it can be updated and utilized to communicate personalized special effect commands.

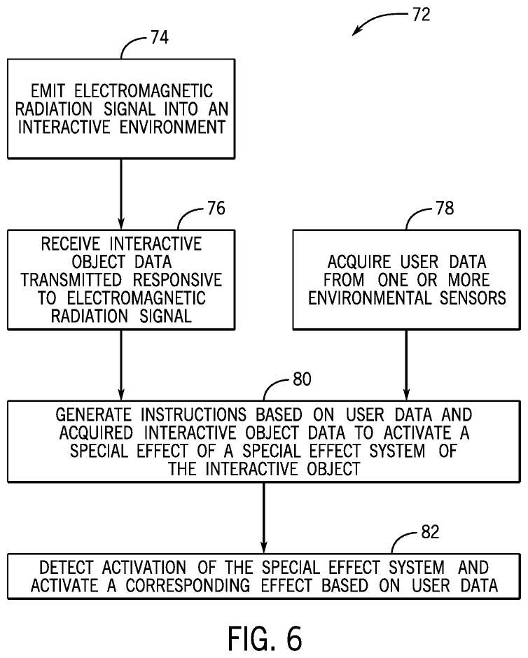

FIG. 6 illustrates a process flow diagram for a method 72 for detection of the interactive object 20 in an interactive environment. The method 72 may include steps that are stored as instructions in the memory 42 and that are executable by the one or more processors 40 of the central controller 18. It should be noted that in some embodiments, steps of the method 72 may be performed in different orders than those shown, or omitted altogether. In addition, some of the blocks illustrated may be performed in combination with each other.

In the illustrated embodiment, the method 72 includes emitting electromagnetic radiation into the area of an interactive environment of the plurality of interactive environments 14 (block 74). The communication circuitry 26 of the interactive object 20 is then triggered by the electromagnetic radiation to emit a wireless signal to transmit the interactive object 20 data to the central controller 18 in the interactive environment 14 (block 76). This signal emitted by the communication circuitry 26 of the interactive object 20 may be facilitated by use of a radio frequency identification (RFID) tag or optical transmitter. The communication circuitry 26 enables communication of the interactive object data to the central controller 18. Concurrently to the interactive object transmission of the interactive object data to the environmental sensors 16 dispersed throughout the interactive environment, the sensors collect user information via facial recognition data, 3D time of flight system data, and other sensor data (block 78). This user information is utilized to facilitate efficiency in user identification within a crowded environment. The multiple forms of user identification enable the user pool to be narrowed down, and make identification of the users 12 in the interactive environment 14 more efficient. For example, in a crowded environment multiple interactive objects 20 and users 12 can be present in the same interactive environment 14. By combining the device data sent via the interactive object 20 to the central control 18, with the sensor data identifying user and tracking interactive object movements, an effect sent from the central controller 18 can be personalized to individual users more efficiently.

For example, in a crowded environment the central controller 18 is able to process all the collected sensor data from the plurality of users 12 and interactive objects 20, and utilize the data to determine the user 12 associated with each of the interactive objects 20. The device information transmitted from the interactive object 20 can include how long the interactive object 20 has been active in the interactive environment 14. For example, in the interactive environment 14 the environmental sensor 16 can communicate interactive object data 20 and user data to the central controller 18. The central controller 18 will then transmit, based on the user profile, a personalized effect signal to the user's interactive object communication circuitry 26 (block 80). Utilizing the user profile information the central controller 18 can recognize that a user has previously visited an area of an interactive environment, and is now revisiting the same area of an interactive environment. In an embodiment, the activation of the special effect is detected by the environmental sensors 16 in the interactive environment 14 to activate or trigger a responsive effect based on the user profile to differentiate the effect from the previous time the user was visiting the area of an interactive environment (block 82). The guest experience can be further personalized through the addition of experience levels to the user profiles. These levels may be determined by how much time the user has spent with the interactive object 20, how many visits they have made to the interactive environment 14, and other additional criteria. The user profile information can be transmitted by the interactive object 20 in conjunction with signals to the central controller 18 to the interactive object 20 so that the effects can further be differentiated based on level of the user 12. This ability of the interactive object 20 to link to user profiles enables a single interactive object 20 to link to multiple users. The overall ability of hardware in the interactive environment and hardware in the user's interactive object 20 to communicate user data, enables dynamic user profiles to be established that include user information built up from previous visits and interactions in the environment, which creates a personalized and updated user experience throughout multiple visits.

While only certain features of the invention have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ” it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
an interactive object, comprising:
a special effect system disposed in or on a housing of the interactive object;
a controller disposed in or on the housing of the interactive object that controls operation of the special effect system;
a plurality of environmental sensors configured to generate sensor data; and
a central controller that operates to:
receive a plurality of user profiles for a plurality of users;
receive sensor data from a plurality of environmental sensors of an interactive environment;
identify a user of the plurality of the users based on the sensor data, wherein the identified user is associated with the interactive object;
characterize a movement or action of the interactive object based on collected data from the environmental sensors; and
communicate instructions to the controller of the interactive object to activate a special effect of the special effect system, wherein the instructions are based on a user profile of the plurality of user profiles, the user profile being associated with the identified user, and the characterized movement or action of the interactive object.

2. The system of claim 1, wherein the plurality of environmental sensors comprise facial recognition sensors, 3D time of flight sensors, radio frequency sensors, optical sensors, or any combination thereof.

3. The system of claim 1, wherein the sensor data comprises facial recognition data, optical data, radio frequency data, motion data, or any combination thereof.

4. The system of claim 1, wherein the interactive object comprises one or more on-board sensors.

5. The system of claim 1, wherein the interactive object comprises a handheld object, wherein the handheld object is a sword, wand, token, book, ball, or figurine

6. The system of claim 1, wherein the interactive object comprises a wearable object, wherein the wearable object is a necklace, medallion, wristband, or hat.

7. The system of claim 1, wherein the interactive object comprises:
a plurality of pressure sensors disposed on an exterior surface of the interactive object in a region corresponding to a grip portion; and
wherein the controller is programmed to:
receive signals from the plurality of pressure sensors;
determine that a grip is associated with the identified user based on the signals; and
generate a control signal to the special effect system based on the grip.

8. The system of claim 1, wherein the special effects system further comprises one or more of a haptic feedback device, a light source, or a sound system, that are activated in response to the instructions.

9. The system of claim 1, wherein the central controller operates to characterize the movement or action by identifying a movement pattern of the interactive object.

10. The system of claim 1, wherein the activated special effect is based on a quality metric of the characterized movement or action.

11. The system of claim 10 wherein a first special effect is activated when the quality metric is above a threshold and a second special effect is activated when the quality metric is below the threshold.

12. The system of claim 9, wherein the activated special effect changes based on corresponding changes to the quality metric.

13. The system of claim 1, wherein the interactive object comprises an optical power harvester that powers the special effect system.

14. A method, comprising:
receiving sensor data from a plurality of sensors in an interactive environment;
identifying a plurality of interactive objects and a plurality of users in the interactive environment based on the sensor data;
associating an identified interactive object with an identified user;
tracking movement of the identified interactive object using the sensor data; and
communicating instructions to the identified interactive object to activate an on-board special effect of the interactive object based on the tracked movement and a user profile of the identified user.

15. The method of claim 13, comprising emitting electromagnetic radiation into the interactive environment and detecting reflection of the electromagnetic radiation by retroreflective markers of the plurality of interactive objects, wherein tracking the movement of the identified interactive object comprises tracking a retroreflective marker associated with the interactive object.

16. The method of claim 15, comprising receiving identification information wirelessly communicated by the plurality of interactive objects to identify the plurality of interactive objects.

17. The method of claim 16, comprising associating the identified interactive object with the retroreflective marker by identifying a closest retroreflective marker based on the sensor data to an original of a wireless signal associated with identification information of the identified interactive object.

18. An interactive object, comprising:
a housing;
a detectable marker disposed on or in the housing that operates to reflect a first portion of electromagnetic radiation from an environment;
communication circuitry on or in the housing that operates to:
receive a second portion of the electromagnetic radiation from the environment;
transmit interactive object identification information of the interactive object responsive to receiving the second portion of the electromagnetic radiation; and
receive special effect instructions;
a controller on or in the housing that receives the special effect instructions and generates a special effect command; and
a special effect system that receives the special effect command and activates a special effect based on the special effect command.

19. The interactive object of claim 18, wherein the detectable marker comprises a retroreflective marker.

20. The interactive object of claim 18, wherein the communication circuitry comprises a radio-frequency identification (RFID) tag or an optical communicator.
